(19) United States
(12) Patent Application Publication
(10) Pub. No.: US 2024/0388776 A1
(43) Pub. Date: Nov. 21, 2024

(54) INTEGRATED ELECTRONIC ASSEMBLY FOR MULTIMEDIA APPARATUS AND CONFERENCE SYSTEM

(71) Applicant: BOE TECHNOLOGY GROUP CO., LTD., Beijing (CN)

(72) Inventors: Yongjie XIANG, Beijing (CN); Yan REN, Beijing (CN)

(21) Appl. No.: 18/258,310

(22) PCT Filed: Jun. 30, 2022
(86) PCT No.: PCT/CN2022/102708

§ 371 Date: Jun. 19, 2023

(51) Int. Cl. H04N 23/51; H04N 7/015; H04N 9/31; H04N 23/52

(52) U.S. Cl. CPC H04N 23/51; H04N 7/015; H04N 9/3141; H04N 23/52

(57) ABSTRACT

An integrated electronic assembly for a multimedia apparatus includes a housing, an image capture device, a screen projection device, a first interface and a second interface provided at the housing. The housing defines an accommodation space. The image capture device and the screen projection device are located in the accommodation space and integrated at the housing. The image capture device is configured to capture a video signal of a scene, and the screen projection device is configured to receive a screen projection signal to be projected and transmit the screen projection signal to the multimedia apparatus. An inner end of the first interface is electrically coupled with the image capture device, and an inner end of the second interface is electrically coupled with the screen projection device, wherein an outer end of the first interface is adapted to be electrically coupled with a first port of the multimedia apparatus to transmit the video signal captured by the image capture device to the multimedia apparatus, and an outer end of the second interface is adapted to be electrically coupled with a screen projection port of the multimedia apparatus to transmit the screen projection signal received by the screen projection device to the multimedia apparatus.

### CROSS REFERENCE TO RELATED APPLICATIONS

The present application is a 35 U.S.C. 371 national stage application of PCT International Application No. PCT/CN2022/102708, filed on Jun. 30, 2022, the contents of which are incorporated herein by reference in their entireties.

### TECHNICAL FIELD

The present application generally relates to an electronic apparatus for a conference system, and in particular relates to an integrated electronic assembly for a multimedia apparatus.

### BACKGROUND

At present, an all-in-one conference machine is usually not integrated with a camera, an audio capture device (such as a microphone) and a projector. In a video conference, it is necessary to additionally purchase and connect an external camera, an external audio capture device (also called a sound pickup device) and an external projector. There are also a few all-in-one conference machines with built-in cameras, but a cost of this kind of all-in-one conference machine with the built-in camera are relatively high, and the attached camera itself does not have a screen projection function and an audio capture function.

The cameras currently available on the market are usually designed separately from the sound pickup device and the projectors, so the cameras themselves usually do not have the screen projection function and the audio capture function. When a video conference is to be held, it is necessary to purchase the camera, the sound pickup device and the projector separately and connect them to the all-in-one conference machine respectively. This kind of camera is designed separately from the sound pickup device and the projector, and therefore connecting wires (such as power lines and signal lines) are numerous and messy. Furthermore, a wire connection mode is complex and unreliable, and signal interference is serious, which cannot meet needs of intelligent conference rooms in the future, and user experiences are poor. Therefore, there exists an urgent need for an improved camera design for an all-in-one conference machine.

### SUMMARY

In order to solve at least one of the above disadvantages, the present disclosure provides an integrated electronic assembly having a function of a camera for a multimedia apparatus.

An integrated electronic assembly for a multimedia apparatus according to some exemplary embodiments of the present application comprises:
a housing defining an accommodation space;
an image capture device and a screen projection device located in the accommodation space and integrated at the housing, wherein the image capture device is configured to capture a video signal of a scene, and the screen projection device is configured to receive a screen projection signal to be projected and transmit the screen projection signal to the multimedia apparatus; and
a first interface and a second interface provided at the housing,
wherein an inner end of the first interface is electrically coupled with the image capture device, and an inner end of the second interface is electrically coupled with the screen projection device,
wherein an outer end of the first interface is adapted to be electrically coupled to a first port of the multimedia apparatus to transmit the video signal captured by the image capture device to the multimedia apparatus,
wherein an outer end of the second interface is adapted to be electrically coupled to a screen projection port of the multimedia apparatus to transmit the screen projection signal received by the screen projection device to the multimedia apparatus.

According to one aspect of the present disclosure, the integrated electronic assembly further comprises an audio capture device located in the accommodation space and integrated at the housing, wherein the inner end of the first interface is also electrically coupled with the audio capture device, and the first port is further configured to receive an audio signal captured by the audio capture device from the first interface.

According to one aspect of the present disclosure, the housing comprises a front shell having a work panel, a back cover opposite to the work panel, and a middle shell located between the front shell and the back cover.

According to one aspect of the present disclosure, the image capture device comprises an image capture lens, and an opening is provided at a center of the work panel for accommodating the image capture lens.

According to one aspect of the present disclosure, the audio capture device comprises an audio capture board with a plurality of audio capture units, and a lower portion of the work panel is provided with a plurality of audio capture through holes for accommodating the plurality of audio capture units.

According to one aspect of the present disclosure, a foam pad is stuck in each audio capture through hole, and a distance between a front surface of the foam pad and an outer surface of the work panel is 0.6-1.0 mm.

According to one aspect of the present disclosure, the distance between the front surface of the foam pad and the outer surface of the work panel is about 0.8 mm.

According to one aspect of the present disclosure, the screen projection device comprises a wireless receiver for receiving the video signal to be projected; and a heat dissipation bracket in thermal contact with the wireless receiver.

According to an aspect of the present disclosure, a front side of the heat dissipation bracket facing the front shell is thermally coupled with the wireless receiver, and at least a portion of the front side of the heat dissipation bracket facing the front shell is abutted against the audio capture device.

According to one aspect of the present disclosure, the heat dissipation bracket comprises a leg extending in a front-rear direction and a foot extending perpendicular to the leg at an end of the leg, and the foot is provided with a bore, and the heat dissipation bracket is fixed to the front shell by putting a screw through the bore.

According to one aspect of the present disclosure, a window is provided at a corner of the work panel, so that the video signal to be projected can reach the wireless receiver through the window.

According to one aspect of the present disclosure, the heat dissipation bracket is an aluminum bracket.

According to one aspect of the present disclosure, the window is covered with a transparent acrylic material.

According to one aspect of the present disclosure, the front shell comprises an elongated convex column extending from its work panel toward the back cover, and the convex column comprises an internally threaded blind hole extending along its longitudinal axis, and an outer periphery of the heat dissipation bracket is provided with a bore, so that the heat dissipation bracket is abutted against the audio capture device by putting a screw through the bore of the heat dissipation bracket and screwing the screw into the internally threaded blind hole.

According to an aspect of the present disclosure, the wireless receiver comprises a receiving antenna.

According to one aspect of the present disclosure, an LED indicator lamp for indicating a working status of the image capture device and a light guide column for guiding light of the LED indicator lamp toward the image capture lens are provided in the accommodation space.

According to one aspect of the present disclosure, the front shell comprises a rectangular groove extending from its work panel toward the back cover, and the rectangular groove is configured to enable the light guide column to slide therein, thereby guiding and positioning the light guide column.

According to one aspect of the present disclosure, a portion of a side wall of the rectangular groove is hollowed out to create a cantilever structure, and a protrusion is provided on a side face of the light guide column, and the rectangular groove is configured such that the cantilever structure of the rectangular groove can create an interference fit with the protrusion on the light guide column when the light guide column slides in the rectangular groove.

According to one aspect of the present disclosure, one end of the light guide column facing the front shell is provided with a bump which partially protrudes into the opening of the work panel.

According to an aspect of the present disclosure, the first interface comprises a plurality of channels, and inner ends of at least part of the plurality of channels are electrically coupled with the image capture device and the audio capture device in parallel.

According to one aspect of the present disclosure, the inner ends of at least part of the plurality of channels are electrically coupled with the image capture device and the audio capture device through USB interfaces, respectively.

According to one aspect of the present disclosure, the first interface is a multi-pin male plug, and the first port of the multimedia apparatus is a multi-pin female plug.

According to one aspect of the present disclosure, the audio capture device is provided with an echo suppression circuit to suppress an echo generated during audio capture.

According to one aspect of the present disclosure, the screen projection device comprises a screen projection control board which controls screen projection. The screen projection control board is fixed on the back cover, and the second interface is provided on the screen projection control board.

According to one aspect of the present disclosure, the second interface is an HDMI interface, and the screen projection port of the multimedia apparatus is an HDMI port, and the HDMI interface and the HDMI port are connected to each other through an HDMI wire.

According to one aspect of the present disclosure, the front shell, the back cover and the middle shell comprises at least one of the following materials: a transparent acrylic material, an ABS engineering plastic and a PC plastic.

According to one aspect of the present disclosure, a ratio of a length, a height and a thickness of the front shell is about 11:1:1.5; and a ratio of a length, a height and a thickness of the middle shell is about 11:2:1.3. A length of the transparent acrylic material at the window is about 10-20% of a length of the work panel of the front shell. A height of the transparent acrylic material at the window is about 90-95% of a height of the work panel of the front shell. A diameter of the image capture lens is about 70-85% of the height of the work panel of the front shell.

The present disclosure also provides a conference system which comprises a integrated electronic assembly and a multimedia apparatus, wherein the multimedia apparatus comprises a power line; a main control board connected with the power line; and a first port and a screen projection port respectively connected to the main control board, wherein a first interface of the integrated electronic assembly is adapted to be electrically coupled to the first port of the multimedia apparatus, and a second interface of the integrated electronic assembly is adapted to be electrically coupled to the screen projection port of the multimedia apparatus.

According to one aspect of the present disclosure, the multimedia apparatus further comprises a touch display panel and a loudspeaker, and the touch display panel also has a function of a writing whiteboard.

### BRIEF DESCRIPTION OF THE DRAWINGS

Other features, objects and advantages of the present application will become more apparent by reading a detailed description of non-limiting embodiments of the present disclosure with reference to the following drawings.

FIG. 1 is a schematic front view of an integrated electronic assembly for an all-in-one conference machine provided by some exemplary embodiments of the present application.

FIG. 2 is a schematic rear view of the integrated electronic assembly for the all-in-one conference machine provided by some exemplary embodiments of the present application.

FIG. 3 schematically shows an exploded view of the integrated electronic assembly for the all-in-one conference machine according to some exemplary embodiments of the present application.

FIG. 4 schematically shows a cut away view of an interior of a front shell of the integrated electronic assembly for the all-in-one conference machine provided by some exemplary embodiments of the present application, in which a light guide column located in a housing of the integrated electronic assembly has been installed into a rectangular groove.

FIG. 5 is a schematic rear view of the front shell and a middle shell of the integrated electronic assembly for the all-in-one conference machine provided by some exemplary embodiments of the present application, in which a back cover has not yet been assembled.

FIG. 6 schematically shows an enlarged perspective view of the light guide column in the housing of the integrated electronic assembly for the all-in-one conference machine provided by some exemplary embodiments of the present application.

FIG. 7 schematically shows an enlarged perspective view of the rectangular groove in the housing of the integrated electronic assembly for the all-in-one conference machine provided by some exemplary embodiments of the present application.

FIG. 8 schematically shows an assembled state of the light guide column of FIG. 6 and the rectangular groove of FIG. 7.

FIG. 9 schematically shows a positional relationship between an audio capture through hole and a foam pad in a work panel of the integrated electronic assembly for the all-in-one conference machine provided by some exemplary embodiments of the present application.

FIG. 10 is a schematic partial cut away view of the front shell of the integrated electronic assembly for the all-in-one conference machine provided by some exemplary embodiments of the present application, in which it shows that the front shell comprises an elongated convex column extending from its work panel toward the back cover, and an image capture device is fastened to the front shell by the convex column.

FIG. 11 is a perspective view of a heat dissipation bracket of a screen projection device of the integrated electronic assembly for the all-in-one conference machine provided by some exemplary embodiments of the present application, wherein a wireless receiver has been assembled on a front side of the heat dissipation bracket facing the front shell.

FIG. 12 is a functional block diagram of a conference system including the integrated electronic assembly and the all-in-one conference machine provided by some exemplary embodiments of the present application.

FIG. 13 is a photo of a finished product of the integrated electronic assembly for the all-in-one conference machine provided by some exemplary embodiments of the present application.

### DETAILED DESCRIPTION

The application will be further described in detail in conjunction with the attached drawings and embodiments. It can be understood that the specific embodiments described here are only for illustrating the disclosure, and are not intended to limit the scope of protection of the disclosure. In addition, for convenience of description, only parts related to the present disclosure are shown in the drawings.

It should be noted that in this application, the embodiments and features of the embodiments can be combined with each other without conflicts. The present application will be described in detail with reference to the attached drawings and embodiments.

For the sake of brevity, only an integrated electronic assembly 200 suitable for an all-in-one conference machine 300 is described below, but it should be understood that the integrated electronic assembly 200 according to the present disclosure can also be used for other multimedia apparatuses, such as televisions, displays, home theaters, personal computers, mobile phones, game consoles, storage devices, etc., so as to facilitate communication, data transmission and/or charging with these apparatuses.

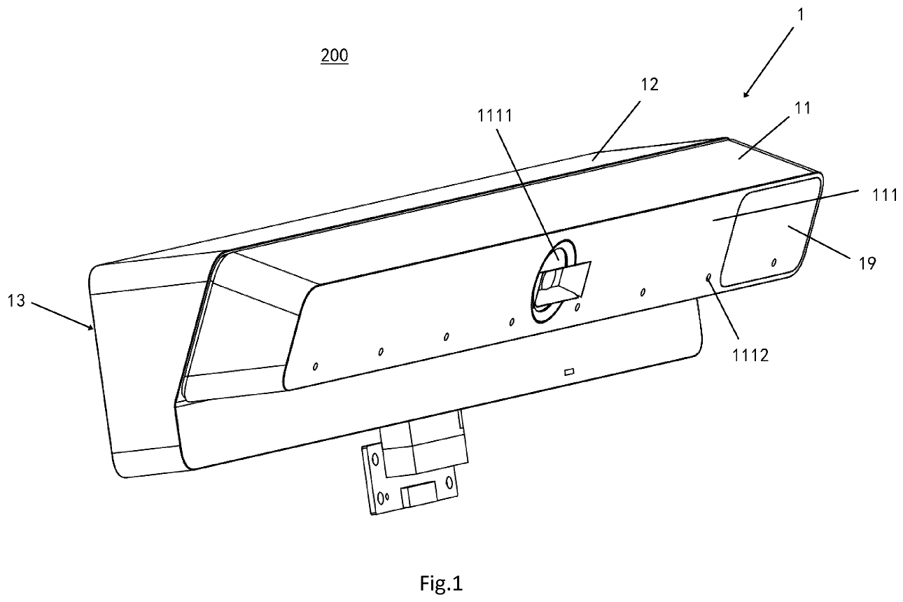

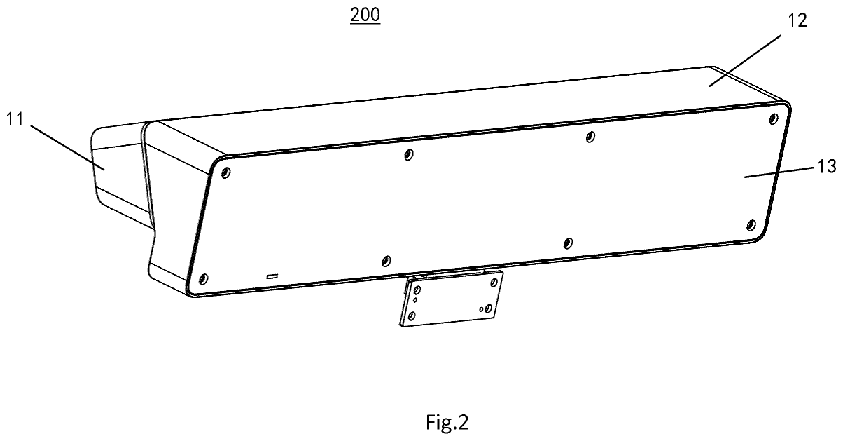

It should be noted that directional expressions “up, down, front, rear (back), horizontal and vertical” in this disclosure are relative concepts, not absolute concepts. When an absolute position of the described object changes, a relative positional relationship may also change accordingly. For convenience and conciseness of description, the present application takes a usual working position of the integrated electronic assembly used in the all-in-one conference machine as a reference, that is, a side of the integrated electronic assembly 200 facing a user in FIG. 1 where a work panel 111 is located is called a forward side or a front side; a side of the integrated electronic assembly 200 in FIG. 2 facing away from the user where a back cover is located is called a back side or a rear side.

In order to solve the technical problems in the prior art, such as separate designs of a camera, a sound pickup device and a projector, numerous and messy connecting wires (such as power lines and signal lines), complicated and unreliable wire connection mode and serious signal interference, the present disclosure provides an integrated electronic assembly having a function of a camera for a conference.

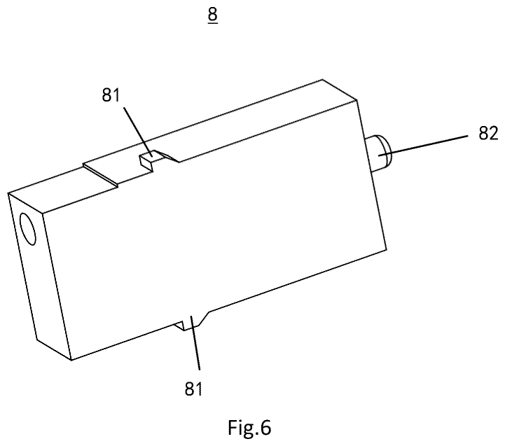

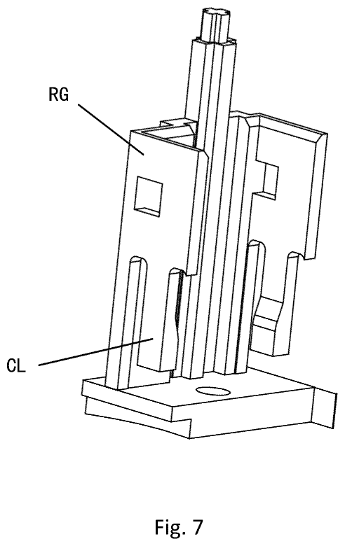

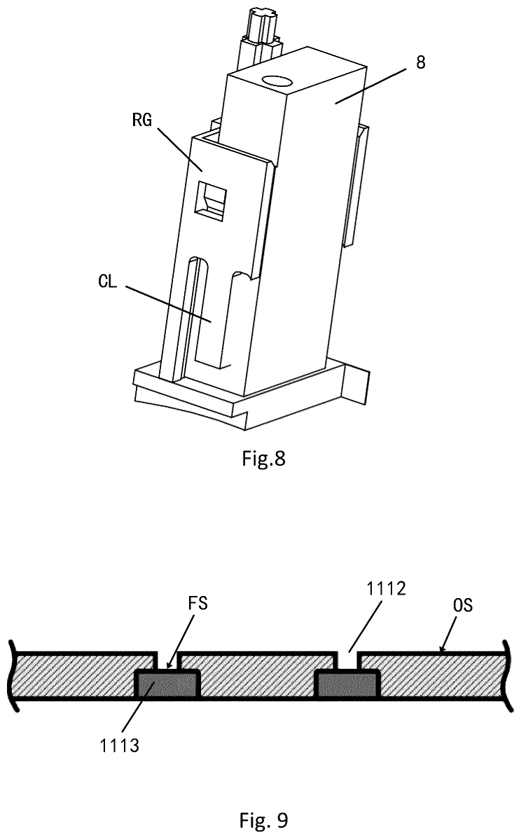

Referring to FIGS. 1-12 together, in some exemplary embodiments, the integrated electronic assembly 200 for the all-in-one conference (e.g., video conference) machine 300 comprises a housing 1 defining an accommodation space; an image capture device and a screen projection device 4 located in the accommodation space and integrated at the housing 1; and a first interface 5 and a second interface 6 provided at the housing. An inner end of the first interface 5 is electrically coupled with the image capture device 2. An inner end of the second interface 6 is electrically coupled with the screen projection device 4. An outer end of the first interface 5 is adapted to be electrically coupled to a first port 320 of the all-in-one conference machine (e.g., all-in-one video conference machine) 300, and an outer end of the second interface 6 is adapted to be electrically coupled to a screen projection port 330 of the all-in-one conference machine 300.

It should be noted that the electrical coupling described in this disclosure is intended to cover both physical connections (such as but not limited to directly plugging into each other, direct wired connection through wires) and non-contact connections (such as wireless communication connections) that are in contact with each other.

According to some exemplary embodiments of the present application, the integrated electronic assembly 200 adopts an integrated appearance design, that is, the image capture device 2 and the projection device 4 are integrated at the housing 1, and the first interface 5 and the second interface 6 at the housing 1 are respectively adapted to be directly connected to the first port 320 and the projection port 330 of the integrated conference machine 300, so that the camera and a screen projection module are integrated together. In this way, one apparatus can have functions of two apparatuses, thereby reducing the number of the apparatuses and saving space for the apparatuses, reducing an overall cost of the apparatus. Therefore, an overall appearance is simple and compact. Connecting wires are few and tidy. A wire connecting operation is simple, the connection has high reliability, and signal interference is small, so the user experience is good.

In order to have an overall understanding of a conference system including the integrated electronic assembly 200 and the all-in-one conference machine 300, the all-in-one conference machine 300 will be briefly described below.

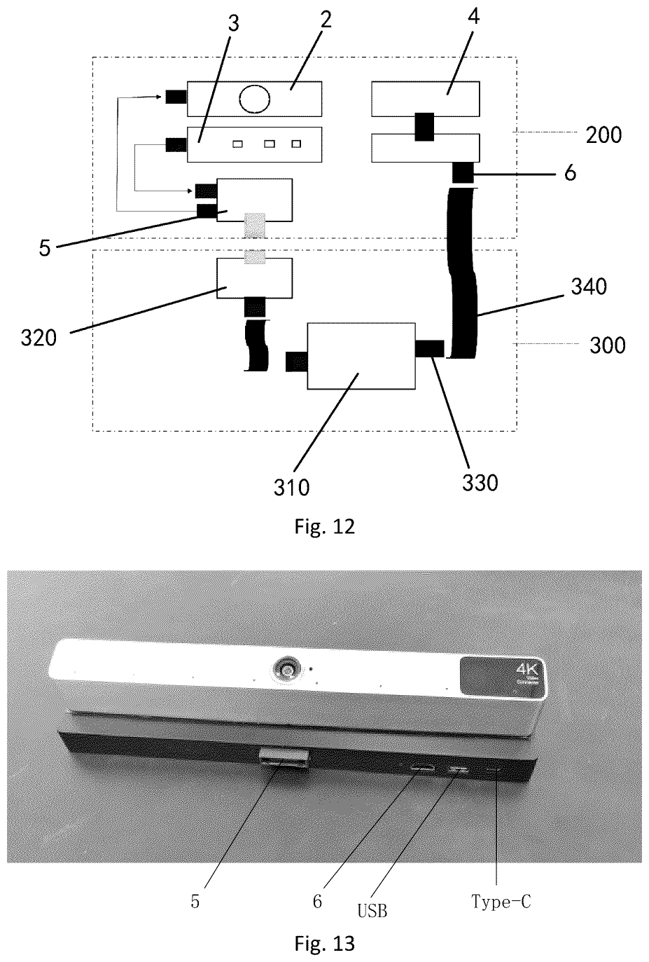

The all-in-one conference machine described herein includes a display screen and a loudspeaker. It is an office apparatus specially designed for meetings, which integrates multiple functions such as functions of a touch screen, an electronic whiteboard and an audio equipment, and has functions of writing, annotation, audio output and video output. It is also called an intelligent all-in-one conference machine. Referring to FIG. 12, the all-in-one conference machine 300 described herein may include a power line (not shown) for supplying power to the all-in-one machine 300 and the integrated electronic assembly 200; a main control board 310 connected to the power line; and the first port 320 and the projection port 330 respectively connected to the main control board 310, wherein the first interface 5 of the integrated electronic assembly is adapted to be electrically coupled to the first port 320 of the all-in-one conference machine, and the second interface 6 of the integrated electronic assembly is adapted to be electrically coupled to the screen projection port 330 of the all-in-one conference machine 300; a touch display panel (not shown) and a loudspeaker (not shown). The touch display panel also has the function of a writing whiteboard.

Next, the integrated electronic assembly 200 used in the all-in-one conference machine 300 will be described in detail.

Optionally, the integrated electronic assembly 200 may further comprises an audio capture device 3 located in the accommodation space and integrated at the housing 1, wherein the inner end of the first interface 5 is also electrically coupled with the audio capture device 3.

The housing 1 comprises: a front shell 11 having a work panel 111, a back cover 13 opposite to the work panel 111, and a middle shell 12 located between the front shell 11 and the back cover 13. The front shell 11, the middle shell 12 and the back cover 13 can be manufactured separately and then assembled together, which is beneficial to reducing a cost and difficulty of manufacture and installation. Of course, the front shell 11 and the middle shell 12 may be integrally molded. The middle shell 12 is usually designed to be larger than the front shell 11 in volume, so that the entire integrated electronic assembly 200 appears to be compact and beautiful. The front shell 11 has a truncated pyramid shape with a cross section gradually decreasing from back to front, which is beneficial to demoulding when molding. In addition, an inventor of this application found that if only the front shell 11 is provided without providing the middle shell 12, it will easily lead to too many components contained in the front shell 11, and thus lead to non-exquisite workmanship, and this will also make the molding of the housing 1 more difficult. In view of this, the inventor of this application designed the whole housing 1 of the integrated electronic assembly 200 in partitions, so that the whole housing comprises the front shell 11, the middle shell 12 and the back cover 13. The housing 1 is relatively easily molded and assembled and has an aesthetics appearance, especially after adding the middle shell 12. Materials of the front shell 11, the back cover 13 and the middle shell 12 may include at least one of the following materials: a transparent acrylic material, an ABS engineering plastic and a PC plastic. The back cover 13 has functions of preventing dust and making the overall bracket aesthetically appealing and tidy.

Next, a dimensional proportional relationship between the front shell 11 and the middle shell 12 will be described exemplarily. For example, a length and a height of the work panel 111 of the front shell 11 can be 318.0±15.0 mm and 29.0±3.0 mm respectively, and a thickness of the front shell 11 in a front-rear direction can be 42.0±4.0 mm, that is, a volume of the front shell 11 is approximately (318.0±15.0) mm*(29.0±3.0) mm*(42.0±4.0) mm. A length, a height and a thickness of the middle shell 12 can be 318.0±15.0 mm, 57.5±5.0 mm and 38.6±4.0 mm respectively, that is, a volume of the middle shell 12 is approximately (318.0±15.0) mm*(57.5±5.0) mm*(38.6±4.0) mm. In addition, a length, a height and a thickness of the transparent acrylic material 19 covered at a window 18 provided at a corner of the work panel 111 can be 49.8±2.0 mm, 26.8=1.5 mm and 0.8±0.1 mm, respectively, that is, a volume of the transparent acrylic material 19 is approximately (49.8±2.0) mm*(26.8±1.5) mm*(0.8±0.1) mm. In addition, a diameter of an opening 1111 provided at a center of the work panel 111 for accommodating an image capture lens 21 can be 23.4±2.0 mm. As to the dimensional proportional relationships, a ratio of the length, height and thickness of the front shell 11 is about 11:1:1.5; a ratio of the length, height and thickness of the middle shell 12 is about 11:2:1.3. The length of the transparent acrylic material 19 at the window 18 is about 10-20% of the length of the work panel 111 of the front shell 11. The height of the transparent acrylic material 19 at the window 18 is about 90-95% of the height of the work panel 111 of the front shell 11. The diameter of the image capture lens 21 is about 70-85% of the height of the work panel 111 of the front shell 11. These dimensional proportional relationships can not only accommodate the internal components of the integrated electronic assembly 200 very well, but also minimize an overall structure of the integrated electronic assembly 200 while facilitating heat dissipation.

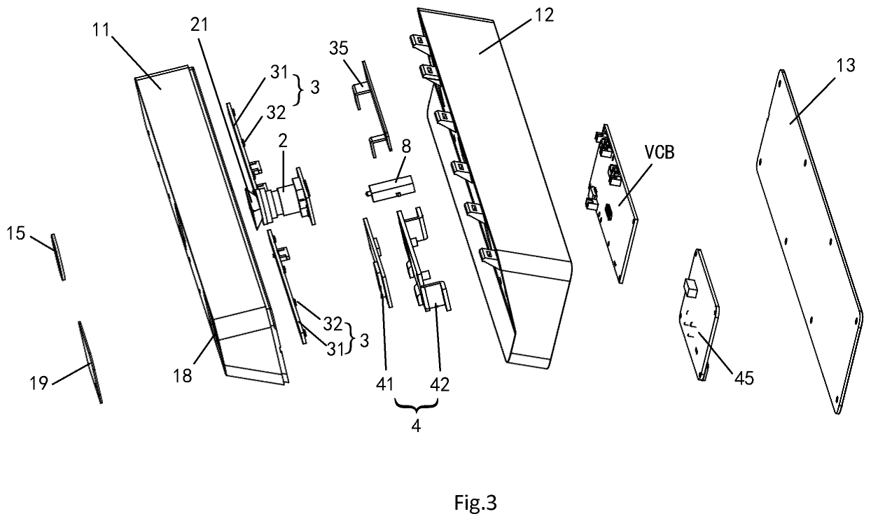

Referring to FIG. 3, the image capture device 2 comprises an image capture lens 21 and a control board VCB for controlling image capture. An opening 1111 is provided at a center of the work panel 111 for accommodating the image capture lens 21. A lens cover 15 with dustproof and beautification functions can also be provided in front of the image capture lens 21.

The audio capture device 3 comprises an audio capture board 31 and a fixing bracket 35 for fixing the audio capture board 31. It should be noted that in FIG. 3, only a side of the audio capture device 3 far away from a heat dissipation bracket 42 is provided with the fixing bracket 35, while a side of the audio capture device 3 adjacent to the heat dissipation bracket 42 is not provided with the fixing bracket 35, because the heat dissipation bracket 42 also has a function of fixing the audio capture board 31 (this will be explained hereinafter). The audio capture board 31 is provided with a plurality of audio capture units 32, and a lower portion of the work panel 111 is provided with a plurality of audio capture through holes 1112 for accommodating the plurality of audio capture units 32. Optionally, a foam pad 1113 is stuck in each audio capture through hole 1112, and a distance between a front surface FS of the foam pad 1113 and an outer surface OS of the work panel 111 is 0.6-1.0 mm, preferably 0.8 mm. After continuous experiments, the inventor of the present application found that setting a height of a pickup hole to be 0.6-1.0 mm can greatly shorten a pickup distance, and a human voice can directly reach each microphone, thus greatly enhancing voice control sensitivity. In addition, the foam can reduce propagation of vibrations of the audio capture unit 32 to the front shell 11, and play a role in positioning and sealing the audio capture unit 32. The audio capture device 3 can also be provided with an echo suppression circuit (not shown) to suppress an echo generated during audio capturing.

The screen projection device 4 comprises a wireless receiver 41 for receiving a video signal to be projected; and a heat dissipation bracket 42 in thermal contact with the wireless receiver 41. The wireless receiver 41 comprises an antenna module 411, and the antenna module 411 comprises a receiving antenna to receive the video signal to be projected. The heat dissipation bracket 42 can generally be made of aluminum, which is a good conductor material of heat. A front side of the heat dissipation bracket 42 facing the front shell 11 is thermally coupled with the wireless receiver 41, and at least a portion of the front face of the heat dissipation bracket 42 facing the front shell 11 is abutted against the audio capture device 3. In addition, as shown in FIG. 3, the heat dissipation bracket 42 comprises a leg LG extending in a front-rear direction and a foot FT extending perpendicular to the leg LG at an end of the leg LG. The foot FT is provided with a bore DH, and the heat dissipation bracket 42 is fixed to the front shell 11 by putting a screw through the bore. The heat dissipation bracket is made of aluminum material, which can dissipate heat quickly. In addition, the heat dissipation bracket also acts as a fixing bracket to position the sound pickup device. It not only plays a role of connecting the screen projection module to dissipate heat, but also plays a role of abutting against the sound pickup device, which eliminates a separate fixing element for the sound pickup device, lowers a cost and saves an overall space of the integrated electronic assembly. Besides, a sound pickup distance is ensured, the sound pickup device is prevented from detaching due to poor adhesive effect between the foam and the sound pickup device, and the sound pickup distance is shortened by compressing the foam.

Referring to FIG. 3, the screen projection device 4 further comprises a screen projection control board 45 for controlling screen projection (i.e., transmitting a received screen projection signal (which may include an audio signal and/or a video signal) to the all-in-one conference machine 300), which is fixed on the back cover 13, and the second interface 6 is provided on the screen projection control board 45.

The screen projection control board 45 is configured to transmit the screen projection signal to the all-in-one conference machine.

In addition, the window 18 is provided at the corner of the work panel 111, so as to cause less interference to the video signal to be projected, and enable it to smoothly reach the wireless receiver 41 through the window 18. The window 18 is covered with the transparent acrylic material 19, which is not only aesthetically appealing, but also has less interference to the video signal to be projected.

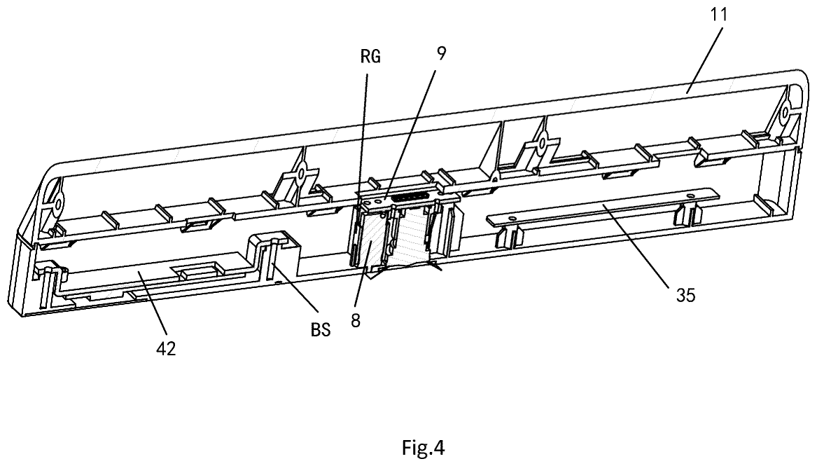

Referring to FIG. 4, the front shell 11 may comprises an elongated convex column BS extending from its work panel 111 toward the back cover 13, and the convex column BS comprises an internally threaded blind hole extending along its longitudinal axis. An outer periphery of the heat dissipation bracket 42 (for example, each of two ends of the heat dissipation bracket 42 in FIG. 4) is provided with a bore DH, and the two ends of the heat dissipation bracket 42 are fastened to the convex column BS of the front shell 11 by screwing screws through the bores DH of the heat dissipation bracket 42. This fastening method for fastening the heat dissipation bracket 42 through the convex column BS has a simple structure and a low cost of manufacture and installation.

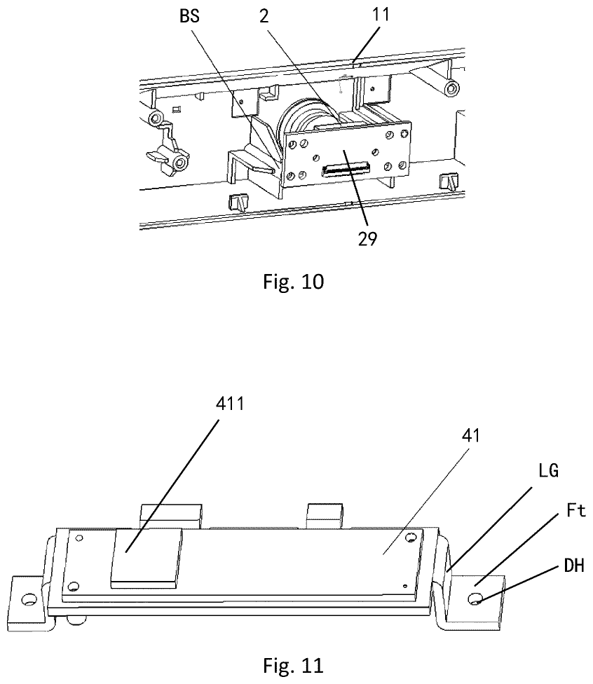

Additionally or alternatively, referring to FIG. 10, the front shell 11 may comprises an elongated convex column BS extending from its work panel 111 toward the back cover 13 for fastening the image capture device 2 to the front shell 11. The convex column BS comprises an internally threaded blind hole extending along its longitudinal axis. When fastening, it is necessary to use a fixing plate 29, which is provided with a screw hole. Specifically, a screw is first put through the screw hole in the fixing plate 29, and then screwed into the internally threaded blind hole in the protruding column BS, thereby fixing the image capture device 2 to the front shell 11 by squeezing the image capture device 2 by means of the fixing plate 29 (or the image capture device 2 can be directly fixed to the fixing plate 29). This way of fastening the image capture device 2 and the front shell 11 by means of the convex column BS has a simple structure and a low cost of manufacture and installation.

Referring to FIG. 4 and FIG. 6-8, as an option, an LED indicator lamp 9 and a light guide column 8 for guiding light of the LED indicator lamp 9 toward the image capture lens 21 can also be provided in the accommodation space defined by the housing 1. The LED indicator lamp 9 is used to indicate a working status of the image capture device 2, for example, when the image capture device 2 is capturing an image, the LED indicator lamp 9 is lit; when the image capture device 2 is not capturing an image but in a standby state, the LED indicator 9 goes out.

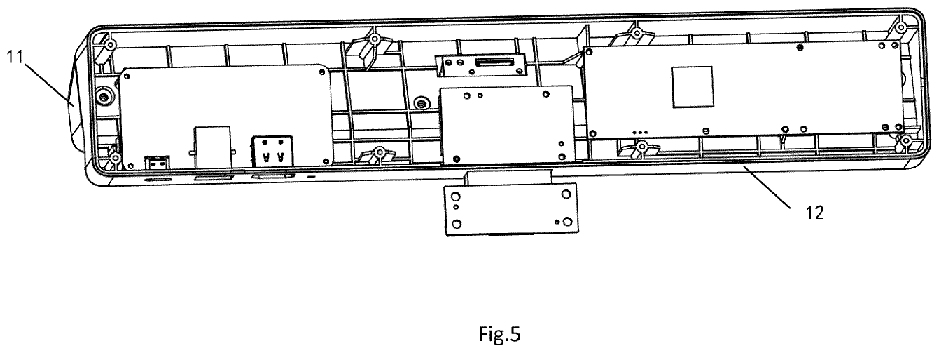

The front shell 11 comprises a rectangular groove RG extending from its work panel 111 toward the back cover, and the rectangular groove RG is configured to enable the light guide column 8 to slide therein, thereby guiding and positioning the light guide column. Optionally, a portion of a side wall of the rectangular groove RG is hollowed out to create a cantilever structure CL, and the light guide column 8 is provided with a protrusion 81 on its side face. The rectangular groove RG is configured such that the cantilever structure CL of the rectangular groove RG can create an interference fit with the protrusion 81 on the light guide column 8 when the light guide column 8 slides in the rectangular groove RG. In addition, an end of the light guide column 8 facing the front shell 11 can be provided with a bump 82 which partially protrudes into the opening 1111 of the work panel 111, so as to better guide the light of the LED indicator lamp 9 into the opening 1111 of the work panel 111 and facilitate the user to perceive the working status of the image capture device 2. On the other hand, the bump 82 also has a function of positioning the light guide column 8. The installation method shown in FIG. 6-8 can fix and limit the light guide column 8 well without using adapters and screws, which saves costs of screws and makes up for an inconvenience of disassembly if using adhesive. The interference fit created between the cantilever structure CL of the rectangular groove RG and the protrusion 81 on the light guide column 8 can more firmly fix and limit the light guide column 8. The bump 82 of the light guide column 8 protrudes into the opening 1111 of the work panel 111 to further limit the light guide column 8.

Referring to FIG. 12, the first interface 5 comprises a plurality of channels, and inner ends of at least some of the plurality of channels are respectively electrically coupled with the image capture device 2 and the audio capture device 3 in parallel through USB interfaces. For example, the first interface 5 is a multi-pin male plug, and the first port 320 of the all-in-one conference machine 300 is a multi-pin female plug. Because distances between the USB interface and the image capture device and the sound pickup device are short, and corresponding connecting wires are also short, thereby improving electrical coupling reliability and reducing signal interference.

Referring to FIG. 12, the second interface 6 is an HDMI interface, and the screen projection port 330 of the all-in-one conference machine 300 is an HDMI port, and the HDMI interface and the HDMI port are connected to each other through an HDMI wire 340. Since the HDMI interface and the HDMI port are connected to each other through an HDMI wire, the connection reliability is high.

Please refer to FIG. 13, which is a photo of a finished product of the integrated electronic assembly for the all-in-one conference machine provided by some exemplary embodiments of the present application. It can be seen from FIG. 13 that a lower surface of the middle shell 12 of the integrated electronic assembly 200 is provided with a USB interface and a Type-C interface as an extension in addition to the first interface 5 and the second interface 6, wherein the USB interface and the Type-C interface of the integrated electronic assembly 200 are respectively communicated with the first interface 5 and the second interface 6 of the integrated electronic assembly 200 through a certain protocol logic. The first interface 5 and the second interface 6 have the same functions as described above. The USB interface and the Type-C interface can be used to connect with a TV set, a display, a home theater, a personal computer, a mobile phone, a game machine, a storage device, etc., so as to facilitate communication, data transmission and/or charging with these apparatuses.

When in use, the video capture device 2 captures a video signal of a scene (for example, a meeting place), and the audio capture device 3 captures an audio signal of the scene (for example, the meeting place) and suppresses an echo generated during audio capturing through an echo suppression circuit. Then, the captured video signal and the captured audio signal are transmitted to the first port 320 of the all-in-one conference machine 300 through the first interface 5. In addition, the screen projection device 4 uses a wireless transmission technology, and a specific working process of the screen projection device 4 is as follows: a screen projection signal (for example, an audio and/or video signal needed to be projected in a personal computer or mobile phone of a participant) is transmitted to the wireless receiver 41 of the screen projection device in a wireless way, and then the screen projection signal (which may include the audio signal and/or the video signal) is transmitted to the screen projection port 300 of the all-in-one machine 300 through the second interface 6 (for example, the HDMI interface) in a wired way. Finally, under the control and scheduling of the main control board 310 of the all-in-one machine 300, on the one hand, the above-mentioned audio signal, video signal and/or screen projection signal can be displayed and output through the touch display panel and the loudspeaker of the all-in-one machine. On the other hand, the above-mentioned audio signal, video signal and/or screen projection signal can also be transmitted to a server connected with the all-in-one conference machine, and then transmitted to another remote party of the conference through the server. Take an application scenario of a remote video conference as an example. A local conference speaker transmits a screen content (also called a screen projection information or screen projection signal) of his own PC or notebook computer to the screen projection device 4 in a wireless way, and then transmits it to the screen projection port 330 of the all-in-one machine 300 through the second interface 6 (for example, HDMI interface) of the integrated electronic assembly 200 in a wired way, so that the screen projection signal can be displayed and output through the touch display panel and the loudspeaker of the all-in-one machine 300, so that local participants can watch the screen content shared by the conference speaker on the all-in-one machine 300. At the same time, the video signal of the local meeting place captured by the video capture device 2 and the audio signal of the local meeting place captured by the audio capture device 3 are transmitted to the first port 320 of the all-in-one conference machine 300 through the first interface 5 of the integrated electronic assembly 200, and the audio signal and video signal are then transmitted to the server connected with the all-in-one conference machine 300, and finally transmitted to another remote party of the conference through the server, so that a receiving apparatus of the participant at a remote end can receive the audio signal and the video signal from the local end.

The integrated electronic assembly 200 provided according to some exemplary embodiments of the present application and the conference system including the integrated electronic assembly 200 have the following beneficial effects.

The integrated electronic assembly 200 for the all-in-one conference machine 300 provided by the present disclosure adopts an integrated appearance design, that is, the image capture device 2, the audio capture device 3 and the projection apparatus 4 are integrated at the housing 1, and the first interface 5 and the second interface 6 at the housing 1 are respectively adapted to be directly connected to the mating first port 320 and projection port 330 of the all-in-one conference machine 300, so that an apparatus space is saved, a total cost of the apparatus is reduced, and an overall appearance is simple and compact. Connecting wires are few and tidy, a wire connection operation is simple, thereby improving the connection reliability and reducing the signal interference, so the user experience is good. In addition, as for the whole video conference system, because of abandoning cumbersome wire plugging and wire connecting used in the past, a file to be projected in a personal computer, an iPad tablet and a mobile phone is directly transmitted to an intelligent conference touch panel for users to watch and discuss. Only one power line is needed to complete the connection. A sound box wire, a camera wire, a microphone wire, a video wire, a network wire, a keyboard wire, a mouse wire, etc. are eliminated. Compared with a traditional split-type conference system, it can save about 30%-70% of desktop space, it is more energy-conserving and environment-protective, and it also has a simple and fashionable appearance.

It should be noted that the integrated electronic assembly 200 suitable for the all-in-one conference machine 300 has been described above as an example, but it should be understood that the integrated electronic assembly 200 according to the present disclosure can also be used for other electronic apparatuses, such as televisions, displays, home theaters, personal computers, mobile phones, game consoles, storage devices, etc., so as to facilitate communication, data transmission and/or charging with these apparatuses.

In an application example, when the integrated electronic assembly 200 according to the present disclosure is applied to a television or a display, it is only necessary to place the integrated electronic assembly 200 according to the present disclosure on or adjacent to the television or the display, and then connect the second interface 6 (for example, the HDMI interface) of the integrated electronic assembly 200 with a corresponding HDMI interface of the television or the display (if the television or the display does not have an HDMI interface, an adapter is required for adaptation or transformation), so that the screen projection signal in the integrated electronic assembly 200 can be displayed and output through the television or the display. Further, the first interface 5 (for example, the multi-pin male plug) of the integrated electronic assembly 200 according to the present disclosure can be connected with a corresponding interface (for example, a DVI interface) of the TV or display through the adapter, so that the video signal captured by the video capture device 2 of the integrated electronic assembly 200 and the audio signal captured by the audio capture device 3 of the integrated electronic assembly 200 can also be output and played through the TV or display.

In an application example, when the integrated electronic assembly 200 according to the present disclosure is applied to a personal computer, such as a PC or a Notebook, it is only necessary to place the integrated electronic assembly 200 according to the present disclosure on or adjacent to the personal computer, and then connect the USB interface of the integrated electronic assembly 200 with an USB interface of the personal computer. Because the USB interface of the integrated electronic assembly 200 is communicated with the first interface 5 and the second interface 6 of the integrated electronic assembly 200 through a certain protocol logic, the screen projection signal in the integrated electronic assembly 200, the video signal captured by the video capture device 2 of the integrated electronic assembly 200 and the audio signal captured by the audio capture device 3 of the integrated electronic assembly 200 can be accessed by the personal computer.

In another application example, when the integrated electronic assembly 200 according to the present disclosure is applied to a mobile phone, only the integrated electronic assembly 200 according to the present disclosure needs to be placed adjacent to the mobile phone, and then the Type-C interface of the integrated electronic assembly 200 is connected with a Type-C interface of the mobile phone. Because the Type-C interface of the integrated electronic assembly 200 is connected with the first interface 5 and the second interface 6 of the integrated electronic assembly 200 through a certain protocol logic, the screen projection signal in the integrated electronic assembly 200, the video signal captured by the video capture device 2 of the integrated electronic assembly 200 and the audio signal captured by the audio capture device 200 of the integrated electronic assembly 200 can be accessed by the mobile phone.

In yet another application example, when the integrated electronic assembly 200 according to the present disclosure is applied to a storage device, it is only necessary to place the integrated electronic assembly 200 according to the present disclosure on or adjacent to the storage device, and then connect the USB interface or Type-C interface of the integrated electronic assembly 200 with a USB interface or Type-C interface of the storage device. Because the USB interface or Type-C interface of the integrated electronic assembly 200 is communicated with the first interface 5 and the second interface 6 of the integrated electronic assembly 200 through a certain protocol logic, the screen projection signal in the integrated electronic assembly 200, the video signal captured by the video capture device 2 of the integrated electronic assembly 200 and the audio signal captured by the audio capture device 3 of the integrated electronic 5 assembly 200 can be stored in the storage device.

Although some exemplary embodiments of the present disclosure have been described and illustrated herein, various other devices and/or structures for performing the functions described herein and/or obtaining the results and/or one or more advantages described herein will easily 10 occur to those of ordinary skill in the art, and each of these changes and/or modifications is considered to be within the scope of the embodiments of the present disclosure. More generally, those skilled in the art will readily understand that all parameters, dimensions, materials and configurations described herein are intended to be exemplary, and the actual parameters, dimensions, materials and/or configurations will depend on one or more specific applications using the teachings of the present disclosure. Those skilled in that art will recognize or be able to find out many equivalents of the specific utility model embodiment described herein using no more than routine experiments. Therefore, it should be understood that the foregoing embodiments are presented by way of example only, and within the scope of the appended claims and their equivalents, the utility model embodiments may be practiced otherwise than as specifically described and claimed. The embodiment of the utility model aims at each individual feature, system, article, material, kit and/or method described herein. Furthermore, if such features, systems, articles, materials, kits and/or methods are not mutually inconsistent, any combination of two or more such features, systems, articles, materials, kits and/or methods is included in the scope of the utility model.

Unless otherwise defined, all technical and scientific terms used in this disclosure have the same meaning as commonly understood by those skilled in the art to which this disclosure belongs.

As used herein in the specification and claims, the phrase “and/or” should be understood to mean “one or two” of the elements so combined, that is, elements that exist in some cases in combination and others that are separated in other cases. Multiple elements listed with “and/or” should be interpreted in the same way, that is, “one or more” of the elements so combined. In addition to the elements specifically identified with the “and/or” clause, other elements may optionally be present, whether related or unrelated to those elements specifically identified. Thus, as a non-limiting example, a reference to “A and/or B” when used in conjunction with an open language such as “includes” may refer to A in one embodiment only (optionally including elements other than B); in another embodiment, limited to B (optionally including elements other than A); in yet another embodiment, both A and B (optionally including other elements), etc.

Those skilled in the art will understand the term “substantially” herein (such as in “substantially all light” or in “consisting essentially of”). The term “substantially” may also include embodiments having “completely”, “entirely”, “all” and the like. Therefore, in the embodiments, adjectives are also basically removable. Where applicable, the term “substantially” can also refer to 90% or higher, such as 95% or higher, especially 99% or higher, even more particularly 99.5% or higher, including 100%. The term “comprising” also includes embodiments in which the term “comprising” means “consisting of”. The term “and/or” relates in particular to one or more of the items mentioned before and after “and/or”. For example, the phrase “Project 1 and/or Project 2” and similar phrases may relate to one or more of Project 1 and Project 2. The term “including” may mean “consisting of” in one embodiment, but it may also mean “including at least the defined species and optionally including one or more other species” in another embodiment.

In addition, the terms first, second, third, etc. in this specification and in the claims are used to distinguish between similar elements and do not indicate any order, quantity or importance. It is to be understood that the terms so used are interchangeable under appropriate circumstances, and that the embodiments of the disclosure described herein are capable of operation in other orders than those described or illustrated herein.

It should be noted that the above-mentioned embodiments illustrate rather than limit the present disclosure, and that those skilled in the art will be able to design many alternative embodiments without departing from the scope of the appended claims. In the claims, any reference signs placed between parentheses shall not be construed as limiting the claims. The use of the verb “comprise” and its conjugations does not exclude the presence of elements or steps other than those stated in the claims. The word “a” or “an” in the claims of this disclosure does not exclude the plural, which is only for the convenience of description and should not be understood as limiting the scope of protection of this disclosure.

The present disclosure can be implemented by means of hardware comprising several distinct elements, and by means of a suitably programmed computer. In a device claim enumerating several devices, several of these devices may be embodied by the same hardware item. The mere fact that certain measures are recited in mutually different dependent claims does not indicate that a combination of these measures cannot be used to advantage.

The present disclosure is further applicable to devices including one or more of the characterizing features described in this specification and/or shown in the drawings. The present disclosure further relates to a method or process including one or more of the characterizing features described in this specification and/or shown in the drawings.

Various aspects discussed in this disclosure can be combined to provide additional advantages. In addition, those skilled in the art will understand that embodiments can be combined, and more than two embodiments can also be combined. In addition, some features may form the basis of one or more divisional applications.

1. An integrated electronic assembly for a multimedia apparatus, comprising:
a housing defining an accommodation space;
an image capture device and a screen projection device located in the accommodation space and integrated at the housing, wherein the image capture device is configured to capture a video signal of a scene, and the screen projection device is configured to receive a screen projection signal to be projected and transmit the screen projection signal to the multimedia apparatus; and
a first interface and a second interface provided at the housing,
wherein an inner end of the first interface is electrically coupled with the image capture device, and an inner end of the second interface is electrically coupled with the screen projection device,
wherein an outer end of the first interface is adapted to be electrically coupled to a first port of the multimedia apparatus to transmit a video signal captured by the image capture device to the multimedia apparatus,
wherein an outer end of the second interface is adapted to be electrically coupled to a screen projection port of the multimedia apparatus to transmit the screen projection signal received by the screen projection device to the multimedia apparatus.

2. The integrated electronic assembly according to claim 1, further comprising an audio capture device located in the accommodation space and integrated at the housing, wherein the inner end of the first interface is also electrically coupled with the audio capture device, and the first port is further configured to receive an audio signal captured by the audio capture device from the first interface.

3. The integrated electronic assembly according to claim 3, wherein the housing comprises a front shell with a work panel, a back cover opposite to the work panel, and a middle shell located between the front shell and the back cover.

4. The integrated electronic assembly according to claim 3, wherein the image capture device comprises an image capture lens, and an opening is provided at a center of the work panel for receiving the image capture lens.

5. The integrated electronic assembly according to claim 3, wherein the audio capture device comprises an audio capture board with a plurality of audio capture units, and a lower portion of the work panel is provided with a plurality of audio capture through holes for receiving the audio capture units.

6. The integrated electronic assembly according to claim 5, wherein a foam pad is stuck in each audio capture through hole, and a distance between a front surface of the foam pad and an outer surface of the work panel is 0.6-1.0 mm.

7. (canceled)

8. The integrated electronic assembly according to claim 5, wherein the screen projection device comprises: a wireless receiver for receiving a screen projection signal to be projected; and a heat dissipation bracket in thermal contact with the wireless receiver.

9. The integrated electronic assembly according to claim 8, wherein a front side of the heat dissipation bracket facing the front shell is thermally coupled with the wireless receiver, and at least a portion of the front side of the heat dissipation bracket facing the front shell is abutted against the audio capture device.

10. The integrated electronic assembly according to claim 9, wherein the heat dissipation bracket comprises a leg extending in a front-rear direction and a foot extending perpendicular to the leg at an end of the leg, the foot is provided with a bore, and the heat dissipation bracket is fixed to the front shell by putting a screw through the bore.

11. The integrated electronic assembly according to claim 1, wherein the work panel is further provided with a window, so that the screen projection signal to be projected can reach the wireless receiver through the window.

12.-13. (canceled)

14. The integrated electronic assembly according to claim 5, wherein the front shell comprises an elongated convex column extending from its work panel towards the back cover, the convex column comprises an internally threaded blind hole extending along its longitudinal axis, and an outer periphery of the heat dissipation bracket is provided with a bore, so that the heat dissipation bracket can be abutted against the audio capture device by putting a screw through the bore of the heat dissipation bracket and screwing the screw into the internally threaded blind hole.

15. (canceled)

16. The integrated electronic assembly according to claim 4, wherein an LED indicator lamp for indicating a working status of the image capture device and a light guide column for guiding light of the LED indicator lamp towards the image capture lens are provided in the accommodation space.

17. The integrated electronic assembly according to claim 16, wherein the front shell comprises a rectangular groove extending from its work panel toward the back cover, the rectangular groove is configured to enable the light guide column to slide therein, thereby guiding and positioning the light guide column.

18. The integrated electronic assembly according to claim 17, wherein a portion of a side wall of the rectangular groove is hollowed out to create a cantilever structure, a protrusion is provided on a side face of the light guide column, and the rectangular groove is configured such that when the light guide column slides in the rectangular groove, the cantilever structure of the rectangular groove and the protrusion on the light guide column can create an interference fit.

19. The integrated electronic assembly according to claim 16, wherein one end of the light guide column facing the front shell is provided with a bump which partially protrudes into the opening of the work panel.

20. The integrated electronic assembly according to claim 2, wherein the first interface comprises a plurality of channels, and inner ends of at least part of the plurality of channels are electrically coupled with the image capture device and the audio capture device in parallel.

21.-22. (canceled)

23. The integrated electronic assembly according to claim 3, wherein the screen projection device comprises a screen projection control board which controls screen projection, the screen projection control board is fixed on the back cover, and the second interface is provided at the screen projection control board.

24. The integrated electronic assembly according to claim 23, wherein the second interface is an HDMI interface, the screen projection port of the multimedia apparatus is an HDMI port, and the HDMI interface and the HDMI port are connected with each other through an HDMI wire.

25.-28. (canceled)

29. A conference system, comprising the integrated electronic assembly according to claim 1 and a multimedia apparatus, wherein the multimedia apparatus comprises: a power line; a main control board connected with the power line; and a first port and a screen projection port respectively connected to the main control board, wherein the first interface of the integrated electronic assembly is adapted to be electrically coupled to the first port of the multimedia apparatus, and the second interface of the integrated electronic assembly is adapted to be electrically coupled to the screen projection port of the multimedia apparatus.

30. The conference system according to claim 29, wherein the multimedia apparatus further comprises a touch display panel and a loudspeaker, and the touch display panel also has a function of a writing whiteboard.
